(19) United States
(12) Patent Application Publication
(10) Pub. No.: US 2023/0151168 A1
(43) Pub. Date: May 18, 2023

(54) METHOD FOR PREPARING SILK FIBROIN FILM BY WET FILM COATING

(71) Applicant: ZHEJIANG LAB, Hangzhou (CN)

(72) Inventors: Haitao LIU, Hangzhou (CN); Lei ZHANG, Hangzhou (CN)

(21) Appl. No.: 18/091,375

(22) Filed: Dec. 30, 2022

Related U.S. Application Data
(63) Continuation of application No. PCT/CN2021/072276, filed on Jan. 15, 2021.

(30) Foreign Application Priority Data
Oct. 29, 2020 (CN) 202011181162.1

(51) Int. Cl. C08J 5/18; C08L 89/00; C08K 5/09; C08K 3/16

(52) U.S. Cl. CPC C08J 5/18; C08L 89/00; C08K 5/09; C08K 3/16; C08J 2389/00; C08L 2203/16; C08K 2003/162

(57) ABSTRACT

Provided is a method for preparing silk fibroin film by wet film coating, including: (1) scrape coating a regenerative silk fibroin wet films on selected substrates, drying, to obtain regenerated silk fibroin films after drying; (2) Putting the dried silk fibroin film in water, so that the silk fibroin film can be detached peeled from the substrate after subsequent drying; and (3) drying Exfoliate the further dried silk fibroin film and peeling from the substrate. It is the first time to realize the preparation of free-standing fibroin film by wet film coating. The silk fibroin film has properties of ultra-thin, flexible, transparent, permeable, excellent biocompatibility, etc., thus being suitable for applications in flexible electronics, such as epidermal electronics. In addition, the method is not only suitable for industrial batch production of the fibroin film, but also matched with the existing film processing technologies such as roll-to-roll and nano-imprint.

### TECHNICAL FIELD

The present disclosure relates to a method of preparing free-standing silk fibroin film, belonging to the field of polymer materials.

### BACKGROUND

In the past decade, flexible electronics have made great progress, but most research achievements have not yet been translated into products. The fact is that the development of flexible electronics in industry lags behind the prosperity of academia. The adoption of new functional materials and manufacturing technology is the prerequisite for the realization of flexible electronics productization. The study of the industrial transformation will determine the commercial success of flexible electronics technology. At present, there are many kinds of materials for flexible electronic applications, and the substrate material is the carrier component of flexible electronic devices, which is the basis for determining the usability, comfort, and manufacturability of flexible products. Therefore, there is a need for a thin, flexible, transparent, breathable, and excellently biocompatible substrate material, and a further need for a low-cost film preparation method as the basis for large-scale industrial production of the substrate material.

Silk fibroin is a fibrous protein extracted from silkworm cocoons by degumming processes. Silk fibroin fiber is a block copolymer, rich in hydrophobic β-sheets, self-assembling to form a strong structural material with high mechanical strength and toughness. Silk fibroin contains 18 kinds of amino acids, in which glycine, alanine, and serine account for 80% or more, similar to the amino acids in human skin keratin. The materials composed of silk fibroin exhibit excellent biocompatibility, and are widely used in skin dressing, anti-adhesion film, dura mater, nerve sheath, cornea, drug sustained-release, cosmetics, and other fields. In addition, silk fibroin films also have excellent dielectric properties, mechanical strength, and degradability, which are ideal substrate alternatives for flexible electronics.

At present, the preparation methods of silk fibroin film include casting (CN105885070B, CN103341214B), suction filtration (Nano Lett. 2016, 16, 3795-3800), etc. There is no literature report on the preparation of free-standing silk fibroin film by the wet film coating method. The film prepared by the casting method is generally thick and difficult to control. The films prepared by directly casting silk protein aqueous solution are brittle, and have poor mechanical properties. Moreover, both casting and filtration methods are not suitable for mass production. These characteristics affect the application prospect of silk fibroin film for flexible electronic products.

In addition, it should be noted that the current wet film coating method is only employed to prepare wet films and does not involve the peeling of the film. Therefore, it is a new topic referring to peeling off the silk fibroin films from the substrate. The suction filtration method can prepare ultra-thin silk fibroin films with thickness of 9 μm or less, but the separation process is complicated. If the free-standing silk fibroin film is prepared by the wet film coating method, the same membrane separation method of the suction filtration method cannot be adopted by the wet film coating method because of the difference in substrates. In fact, not only the preparation of silk fibroin film, but in preparation of other types of ultrathin film with thickness of 9 μm or less, how to separate film and make the obtained film having good free-standing has been a technical difficulty in the field of thin-film preparation. Current methods for separating other types of thin films from substrates, such as sacrificial layer assisting etching, are complex.

### SUMMARY

The purpose of the present disclosure is to provide a method for preparing silk fibroin film by wet film coating.

To realize the above purpose, the technical solution of the present disclosure is as follows: the method for preparing silk fibroin film by wet film coating includes the following steps:
(1) Scrape coating a regenerative silk fibroin wet film on a substrate, drying, to obtain a regenerative silk fibroin film;
(2) putting the regenerative silk fibroin film in water, so that the regenerative silk fibroin film can be peeled from the substrate after subsequent drying; and
(3) drying the regenerative silk fibroin film and peeling from the substrate.

Further, the regenerative silk fibroin wet film includes silk protein and formic acid.

Further, the regenerative silk fibroin wet film further includes inorganic salt.

Further, the inorganic salt is an inorganic salt of lithium or calcium.

Further, the material of the substrate is PET or PI.

Further, the thickness of the regenerative silk fibroin wet film is in the range of 0.1 μm to 200 μm.

Further, in the step (2), putting the regenerative silk fibroin film in water for 0.1 min to 20 min.

Further, the droplet contact angle of the substrate is less than 90°.

Further, in step (2), putting the regenerative silk fibroin film in water is soaking or rinsing the regenerative silk fibroin film with water.

Compared with the prior art, there are the following beneficial effects:

(1) The present disclosure scrape coating a silk fibroin wet film by a wet film coating, then the wet film is dried, and put directly in water (such as soaking or rinsing in water). These processes can help to effectively mechanically peel the regenerative silk fibroin film from the substrate to obtain a regenerative silk fibroin film having good free-standing. It is the first time to realize the preparation of free-standing silk fibroin film by wet film coating.

(2) In addition, the present disclosure adopts the method of drying the silk fibroin wet film and directly putting it in water for treatment (such as soaking or rinsing with water), which effectively solves the problem of separating the silk fibroin film from the substrate in the process of preparing the silk fibroin film by wet film coating. Compared with the suction filtration method and sacrificial layer assisted etching method, the film separation method used in the present disclosure is more simple, effective, and reliable, and can be used to prepare the ultra-thin silk fibroin film with a thickness of 9 μm or less. In addition, it should be noted that the regenerative silk fibroin film is generally amorphous structure, and soluble in water. However, the silk fibroin wet film in the present disclosure is directly treated with water without other treatment after drying, and the silk fibroin film is not dissolved, making the silk fibroin film being peeled successfully from the substrate to obtain a regenerative silk fibroin film having good free-standing, thus achieving unexpected technical effects.

(3) The present disclosure adopts the method of directly putting the dried regenerative silk fibroin wet film in water, which can induce the silk fibroin film to form a high content of β-sheet structure. The as-prepared silk fibroin film exhibits excellent mechanical properties, with a tensile strength at 5 MPa to 40 MPa, and elongation at break up to 1% to 5%. It is more convenient to prepare flexible and ultra-thin silk fibroin film in contrast to conventional casting method and suction filtration method.

(4) The films exhibit better flatness when the contact angle of the substrate is less than 90°. Moreover, the prepared silk fibroin film has greater than 90% of transmittance in the visible band, less than 2% of haze. It also shows excellent water permeability (under the test conditions of exposure window about 3.14 mm² and heating at 80° C., the water permeability can be greater than 1×10⁵ g·m⁻²·day⁻¹).

(5) The method can be adopted to prepare silk fibroin film with ultra-thin, flexible, transparent, and permeable properties. The prepared silk fibroin film has a thickness as low as 0.01 μm to 100 μm, and a weight of 2 g/m² to 20 g/m². The silk fibroin film exhibits excellent conformation adhesion ability with three-dimensional surfaces and maintains excellent biocompatibility, thus being suitable for application in flexible electronics such as epidermal electronics, and biomedical fields.

(6) The method of preparing silk fibroin film is simple and convenient, low cost, and has short cycle periods. The scrape coating, drying, rinsing, and peeling processes can be carried out continuously, which is not only suitable for industrial batch production but also matched with the existing film processing technologies such as roll-to-roll and nano-imprinting, etc., which is easy to prepare patterned functional film.

### BRIEF DESCRIPTION OF DRAWINGS

FIG. 1 shows a digital photo of the ultra-thin and flexible silk fibroin film obtained in Example 1.

FIG. 2 shows an UV-vis diffuse reflectance spectrum of the ultra-thin and flexible silk fibroin film obtained in Example 1.

FIG. 3 shows a mechanical tensile curve of the ultra-thin and flexible silk fibroin film obtained in Example 2.

FIG. 4 shows a SEM image of the ultra-thin and flexible silk fibroin film obtained in Example 2.

FIG. 5 shows a thermogravimetric analysis spectrum of the ultra-thin and flexible silk fibroin film obtained in Example 3.

FIG. 6 shows a FT-IR spectrum of the ultra-thin and flexible silk fibroin film obtained in Example 3.

FIG. 7 shows a SEM image of the cross-section of the ultra-thin and flexible silk fibroin film obtained in Example 3.

FIG. 8 shows the FT-IR spectrum of the amide I band in Example 3.

### DESCRIPTION OF EMBODIMENTS

The commercially available wet film coating devices (such as a scraper, four-side preparation device, wire rod, etc.) can be used to scrape and coat the regenerative silk fibroin wet film on a substrate. The preset scraping thickness ranges from 0.1 μm to 1000 μm. In addition, the present disclosure uses common regenerative silk fibroin solution, such as the mixture of silk fibroin, formic acid, and inorganic salts (such as an inorganic salt of lithium or calcium), and the mixture of silk fibroin and hexafluoro-isopropyl alcohol (HFIP), etc. These raw materials are easy-to-get and low-cost. The silk fibroin can be selected from mulberry silk fibroin, tussah silk fibroin, castor silk fibroin, Antheraea Yamamai silk fibroin, and so on. For peeling mechanically the regenerative silk fibroin film from the substrate after drying, the regenerative silk fibroin film is treated by being put in water, such as soaking or rinsing. The time in water can be adjusted depending on the hydrophilic properties of the substrate and thickness of the film. Generally, the more hydrophilic the substrate, the shorter the time putting in water required; and the thinner the film, the shorter the time putting in water required. The contact angle of the substrate used in the present disclosure is preferably less than 90°, so that the obtained silk fibroin film will has a better flatness.

Further descriptions with specific examples and figures are shown as below.

### EXAMPLE 1

0.5 wt % LiCl/formic acid solution was prepared, 0.4 g degummed silk fibers were dissolved in 7.8 mL of the above solution and ultrasonicated for 1 h. The solution was filtered by PTFE membrane with pore diameter of 0.45 μm to obtain the regenerative silk fibroin solution.

A clean PET substrate with a contact angle of 79.1° was used, and a film scraper with a scraper of 0.1 μm thickness was preset. A regenerative silk fibroin film was scrape-coated onto the substrate. The substrate coated with the wet film was placed on a hotplate at 60° C. for 5 min, immersed in water for 0.5 min, then dried at 60° C. on the hotplate. After dried, the regenerative silk fibroin film was peeled off mechanically from the substrate, obtaining a free-standing flexible silk fibroin film with about 0.05 μm thickness and having good flatness.

### EXAMPLE 2

8.7 wt % LiBr/formic acid solution was prepared, 2.5 g degummed silk fibers were dissolved in 5.7 mL of the above solution and ultrasonicated for 1 h. The solution was filtered by PTFE membrane with pore diameter of 0.45 μm to obtain the regenerative silk fibroin solution.

A clean PI substrate with a contact angle of 82° was used, and a four-side preparation device with 200 μm thickness was employed. A regenerative silk fibroin film was scrape-coated onto the substrate. The substrate coated with the wet film was placed on a hotplate at 60° C. for 10 min, immersed in water for 20 min, then dried at 60° C. on the hotplate. After dried, the regenerative silk fibroin film was peeled off mechanically from the substrate, obtaining a free-standing flexible silk fibroin film with about 25 μm thickness and having good flatness.

### EXAMPLE 3

4.8 wt % CaCl₂/formic acid solution was prepared, 1.3 g degummed silk fibers were dissolved in 6.8 mL of the above solution and ultrasonicated for 1 h. The solution was filtered by PTFE membrane with pore diameter of 0.45 μm to obtain the regenerative silk fibroin solution.

A clean PET substrate with a contact angle of 85° was used, and a four-side preparation device with 100 μm thickness was employed. A regenerative silk fibroin film was scrape-coated onto the substrate. The substrate coated with the wet film was placed on a hotplate at 60° C. for 10 min, immersed in water for 5 min, then dried at 60° C. on the hotplate. After dried, the regenerative silk fibroin film was peeled off mechanically from the substrate, obtaining a free-standing flexible silk fibroin film with about 9 μm thickness and having good flatness.

### EXAMPLE 4

4.8 wt % CaCl₂/formic acid solution was prepared, 1.3 g degummed silk fibers were dissolved in 6.8 mL of the above solution and ultrasonicated for 1 h. The solution was filtered by PTFE membrane with pore diameter of 0.45 μm to obtain the regenerative silk fibroin solution.

A clean PET substrate with a contact angle of 90.4° was used, and a four-side preparation device with 100 μm thickness was employed. A regenerative silk fibroin film was scrape-coated onto the substrate. The substrate coated with the wet film was placed on a hotplate at 60° C. for 10 min, immersed in water for 5 min, then dried at 60° C. on the hotplate. After dried, the regenerative silk fibroin film was peeled off mechanically from the substrate, obtaining a free-standing flexible silk fibroin film with about 13 μm thickness and having good flatness.

### EXAMPLE 5

4.8 wt % CaCl₂/formic acid solution was prepared, 1.3 g degummed silk fibers were dissolved in 6.8 mL of the above solution and ultrasonicated for 1 h. The solution was filtered by PTFE membrane with pore diameter of 0.45 μm to obtain the regenerative silk fibroin solution.

A clean PET substrate with a contact angle of 79.1° was used, and a film scraper with a scraper of 0.02 μm thickness was preset. A regenerative silk fibroin film was scrape-coated onto the substrate. The substrate coated with the wet film was placed on a hotplate at 60° C. for 5 min, immersed in water for 0.1 min, then dried at 60° C. on the hotplate. After dried, the regenerative silk fibroin film was peeled off mechanically from the substrate, obtaining a free-standing flexible silk fibroin film with about 0.01 μm thickness and having good flatness

FIG. 1 shows the digital photo of the silk fibroin film prepared in Example 1. Where, FIG. 1a shows the photo shot as placing the signing pen on the back of the film, and FIG. 1b shows the photo of the film pinched by fingers. It can be seen from FIGS. 1a and 1b, the silk fibroin film obtained exhibits excellent flexibility, transparency, and flatness.

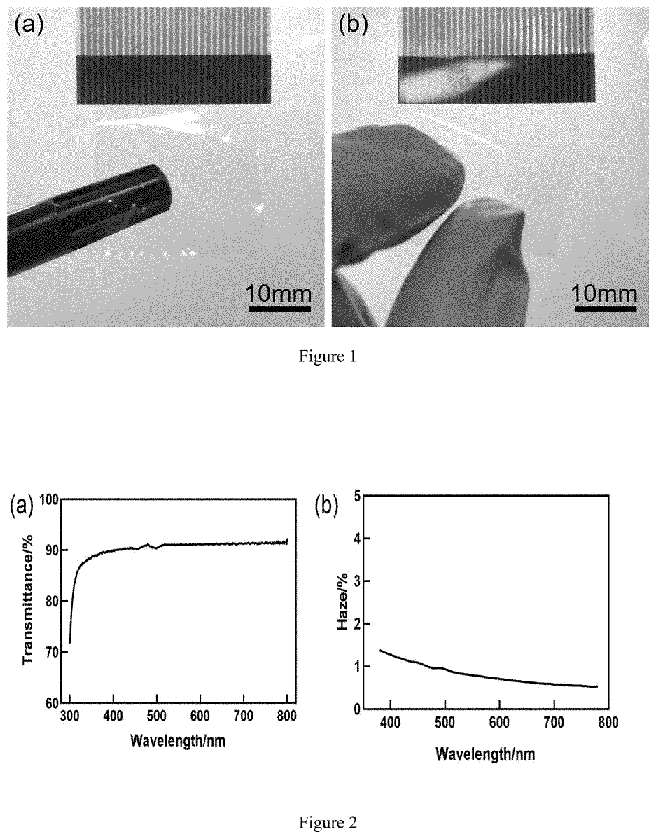

FIG. 2 shows the UV-vis diffuse reflectance spectrum of the silk fibroin film obtained in Example 1, including the results of transmittance (FIG. 2a) and haze (FIG. 2b). It can be seen from FIG. 2, the silk fibroin film obtained exhibits >90% transparency in the visible band, and <2% optical haze by haze test.

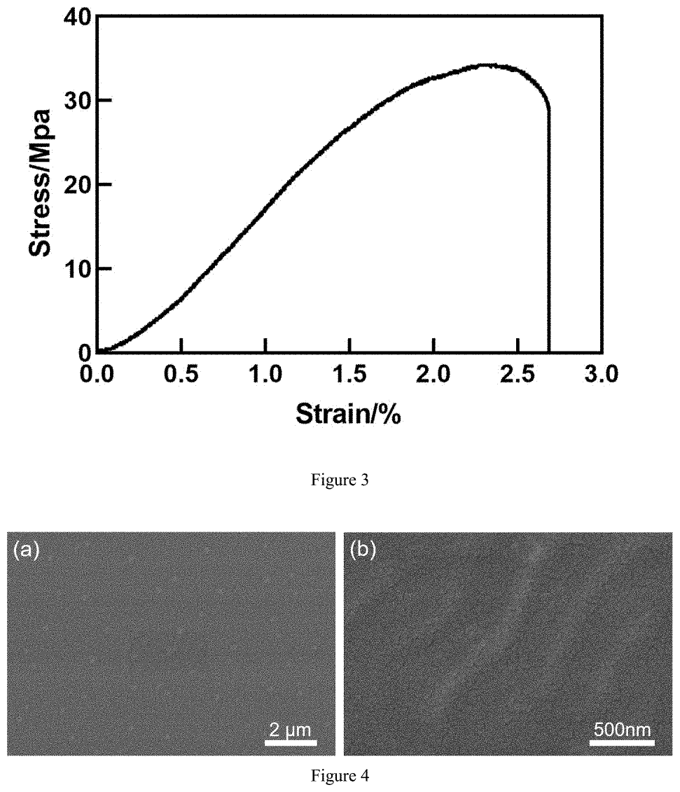

FIG. 3 shows the mechanical tensile curve of the silk fibroin film obtained in Example 2. It can be seen from FIG. 3, the silk fibroin film exhibits >30 MPa tensile strength, up to 2.4% elongation at break, and Young's modulus is calculated for 15.8 MPa. Thus the tensile strength and the Young's modulus are obviously more than the silk fibroin gel film rich in water molecules.

FIG. 4 shows the SEM image of the silk fibroin film surface obtained in Example 2. Where, FIG. 4a is a higher magnification scanning electron microscope image, and FIG. 4b is a lower magnification scanning electron microscope image. It can be seen from FIG. 4, the silk fibroin film surface has a smooth surface and low roughness. The surface crystalline particles fluctuation is in nanometer level. There is no fibrous structure that can be observed on the surface.

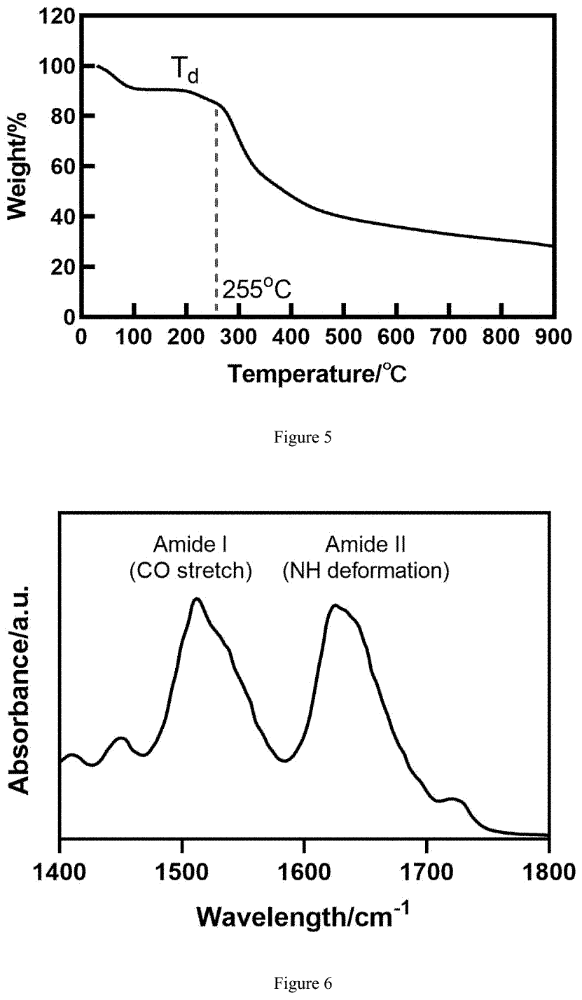

FIG. 5 shows the thermogravimetric curve of the silk fibroin film obtained in Example 3. It can be seen from FIG. 5, the initial decomposition temperature of the silk fibroin film is 255° C., indicating that the film has good thermal processing performance compared with conventional plastic films. For example, metal electrodes can be evaporated on its surface.

FIG. 6 shows the FT-IR spectrum of the silk fibroin film obtained in Example 3. It can be seen from FIG. 6, the silk fibroin film exhibits absorption peaks centered at 1512 cm⁻¹ and 1626 cm⁻¹, respectively, indicating that the film contains stable silk II structures (β-sheet structure).

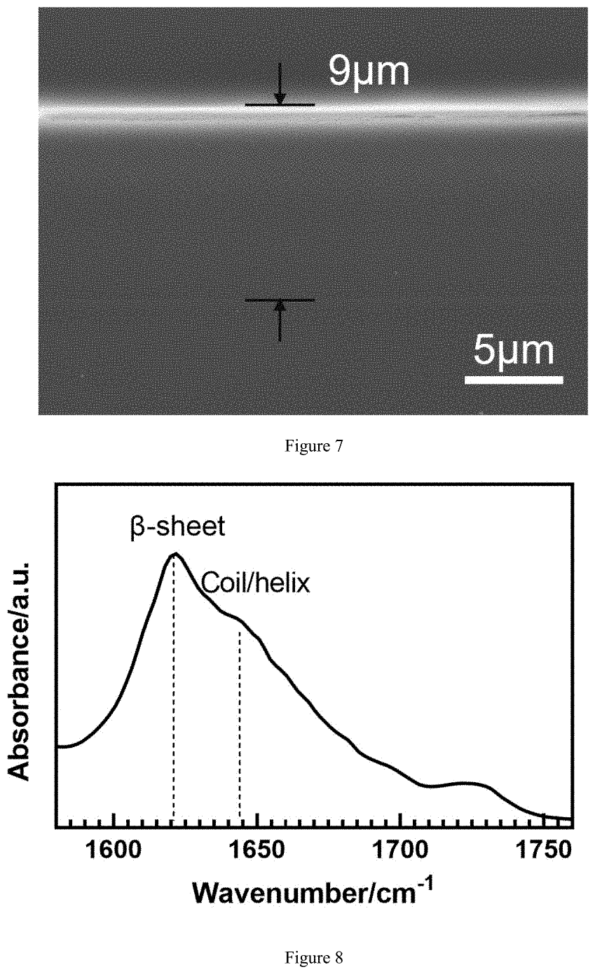

FIG. 7 shows the SEM image of the cross-section of the silk fibroin film obtained in Example 3. The sample is prepared by resin embedding and thinning. It can be seen from FIG. 7, the thickness of the silk fibroin film is about 9 μm. There is no fibrous structure in the cross-section.

FIG. 8 is the FT-IR spectrum of the amide I band of the silk fibroin film obtained in Example 3. It can be seen from FIG. 8, the direct water treatment of the film results in a high content of β-sheets, which is helpful to form a flexible film with stable mechanical properties.

What is claimed is:

1. A method for preparing silk fibroin film by wet film coating comprising:
(1) scrape coating a regenerativable silk fibroin wet film on a substrate, drying, to obtain a regenerativable silk fibroin film, wherein the thickness of the regenerativable silk fibroin wet film is in the range of 0.1 μm to 200 μm;
(2) putting the regenerativable silk fibroin film in water for 0.1 min to 20 mins, so that the regenerativablesilk fibroin film can be peeled from the substrate after subsequent drying; and
(3) drying the regenerativable silk fibroin film and peeling from the substrate.

2. The method according to claim 1, wherein, the regenerativable silk fibroin wet film comprises silk protein and formic acid.

3. The method according to claim 2, wherein, the regenerativable silk fibroin wet film further comprises inorganic salt.

4. The method according to claim 3, wherein, the inorganic salt is an inorganic salt of lithium or calcium.

5. The method according to claim 1, wherein, material of the substrate is PET or PI.

6. The method according to claim 2, wherein, material of the substrate is PET or PI.

7. The method according to claim 3, wherein, material of the substrate is PET or PI.

8. The method according to claim 4, wherein, material of the substrate is PET or PI.

9. The method according to claim 1, wherein, droplet contact angle of the substrate is less than 90°.

10. The method according to claim 2, wherein, droplet contact angle of the substrate is less than 90°.

11. The method according to claim 3, wherein, droplet contact angle of the substrate is less than 90°.

12. The method according to claim 4, wherein, droplet contact angle of the substrate is less than 90°.

13. The method according to claim 5, wherein, droplet contact angle of the substrate is less than 90°.

14. The method according to claim 6, wherein, droplet contact angle of the substrate is less

15. The method according to claim 7, wherein, droplet contact angle of the substrate is less than 90°.

16. The method according to claim 8, wherein, droplet contact angle of the substrate is less than 90°.

17. The method according to claim 1, wherein, in step (2), putting the regenerativable silk fibroin film in water is soaking or rinsing the regenerativable silk fibroin film with water.

18. The method according to claim 2, wherein, in step (2), putting the regenerativable silk fibroin film in water is soaking or rinsing the regenerativable silk fibroin film with water.

19. The method according to claim 3, wherein, in step (2), putting the regenerativable silk fibroin film in water is soaking or rinsing the regenerativable silk fibroin film with water.

20. The method according to claim 4, wherein, in step (2), putting the regenerativable silk fibroin film in water is soaking or rinsing the regenerativable silk fibroin film with water.
